(19) United States
(12) Patent Application Publication
(10) Pub. No.: US 2019/0013047 A1
(43) Pub. Date: Jan. 10, 2019

(54) IDENTIFYING INTERESTING PORTIONS OF VIDEOS

(71) Applicant: Google Inc., Mountain View, CA (US)

(72) Inventors: Arthur Wait, Menlo Park, CA (US); Krishna Bharat, Palo Alto, CA (US); Caroline Rebecca Pantofaru, Menlo Park, CA (US); Christian Frueh, Mountain View, CA (US); Matthias Grundmann, Atlanta, GA (US); Jay Yagnik, Santa Clara, CA (US); Ryan Michael Hickman, Sunnyvale, CA (US)

(21) Appl. No.: 14/675,408

(22) Filed: Mar. 31, 2015

Related U.S. Application Data
(60) Provisional application No. 61/973,120, filed on Mar. 31, 2014.

(51) Int. Cl. G11B 27/00; G11B 27/06; G11B 27/30; G11B 27/34; G06K 9/00

(52) U.S. Cl. CPC G11B 27/002; G11B 27/06; G06K 9/00751; G11B 27/34; G06K 9/00765; G11B 27/3081

(57) ABSTRACT

A plurality of videos is analyzed (in real time or after the videos are generated) to identify interesting portions of the videos. The interesting portions are identified based on one or more of the people depicted in the videos, the objects depicted in the videos, the motion of objects and/or people in the videos, and the locations where people depicted in the videos are looking. The interesting portions are combined to generate a content item.

### CROSS-REFERENCE TO RELATED APPLICATIONS

This application claims the benefit of U.S. Provisional Application No. 61/973,120, entitled, “IDENTIFYING INTERESTING PORTIONS OF VIDEOS,” filed Mar. 31, 2014, the entire content of which are incorporated herein by reference.

### BACKGROUND

Computing devices such as smart phones, cellular phones, laptop computers, desktop computers, netbooks, tablet computers, etc., are commonly used for a variety of different purposes. Users often use computing devices to use, play, and/or consume digital media items (e.g., view digital images, watch digital video, and/or listen to digital music). Users also use computing devices to view videos of real-time events (e.g., an event that is currently occurring) and/or previous events (e.g., events that previously occurred and were recorded). An event may be any occurrence, a public occasion, a planned occasion, a private occasion, and/or any activity that occurs at a point in time. For example, an event may be a sporting event, such as a basketball game, a football game, etc. In another example, an event may be a press conference or a political speech/debate.

Videos of events are often recorded and the videos are often provided to users so that the users may view these events. The events may be recorded from multiple viewpoints (e.g., a football game may be recorded from the sidelines and from the front end and back end of a field). These multiple videos may be provided to users to allow users to view the event from different viewpoints and angles.

### SUMMARY

The below summary is a simplified summary of the disclosure in order to provide a basic understanding of some aspects of the disclosure. This summary is not an extensive overview of the disclosure. It is intended to neither identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

In one embodiment, a method of identifying interesting portions for videos is performed. A plurality of videos of an event is received. Each video originates from a camera in a plurality of cameras. The videos are synchronized in time and each video is associated with a viewpoint of the event. A first interesting portion in a first video of the plurality of videos and a second interesting portion in a second video of the plurality of videos are identified. The first interesting portion is associated with a first time period and the second interesting portion is associated with a second time period. A content item including the first interesting the portion and second interesting portion is generated.

In additional embodiments, computing devices for performing the operations of the above described embodiments are also implemented. Additionally, in embodiments of the disclosure, a computer readable storage media stores methods for performing the operations of the above described embodiments.

### BRIEF DESCRIPTION OF THE DRAWINGS

The present disclosure will be understood more fully from the detailed description given below and from the accompanying drawings of various embodiments of the present disclosure, which, however, should not be taken to limit the present disclosure to the specific embodiments, but are for explanation and understanding only.

FIG. 1A is a block diagram illustrating an example camera architecture, in accordance with one embodiment of the present disclosure.

FIG. 1B is a block diagram illustrating an example camera architecture, in accordance with another embodiment of the present disclosure.

FIG. 1C is a block diagram illustrating an example camera architecture, in accordance with a further embodiment of the present disclosure.

FIG. 2 is a block diagram illustrating example videos, in accordance with one embodiment of the present disclosure.

FIG. 3 is a block diagram illustrating an example system architecture, in accordance with one embodiment of the present disclosure.

FIG. 4 is a block diagram illustrating a saliency module, in accordance with one embodiment of the present disclosure.

FIG. 5 is a flow diagram illustrating a method of identifying interesting portions of videos, in accordance with one embodiment of the present disclosure.

FIG. 6 is a flow diagram illustrating a method of identifying interesting portions of videos, in accordance with another embodiment of the present disclosure.

FIG. 7 is a block diagram of an example computing device that may perform one or more of the operations described herein.

### DETAILED DESCRIPTION

The following disclosure sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely examples. Particular implementations may vary from these example details and still be contemplated to be within the scope of the present disclosure.

Capturing high-quality video of events (such as sports games, concerts, lectures, meetings, weddings, etc.) requires a commitment of time and resources. Multiple cameras may typically be employed to capture the action from multiple viewpoints (e.g., points of view). A human operator for each camera may point the camera in the direction of salient or interesting objects, people and/or occurrences in the event. Additional personnel may be used to select portions of the videos and edit the footage from the cameras into a final video. If the event is being broadcast live, additional personnel may be used to direct the live broadcast (e.g., to instruct the camera operators and to determine which camera view should be broadcast at a given time).

Embodiments of the disclosure pertain to identifying interesting portions of videos of an event. An interesting portion of a video of an event refers to one or more objects or persons (e.g., a speaker at a conference, a soccer filed at a soccer game, a dance floor at a wedding, etc.) that represent a center of attention for a viewer and/or participant of an event captured in a video. A plurality of videos may be analyzed (in real time or after the videos are generated) to identify interesting portions of the videos. The interesting portions may be identified based on one or more of the people depicted in the videos, the objects depicted in the videos, the motion of objects and/or people in the videos, and the locations where people depicted in the videos are looking. The interesting portions may be combined to generate a video. The interesting portions may be identified automatically by a computing device and the video may be generated automatically. This may allow a video of an event to be generated more quickly, easily, and/or efficiently.

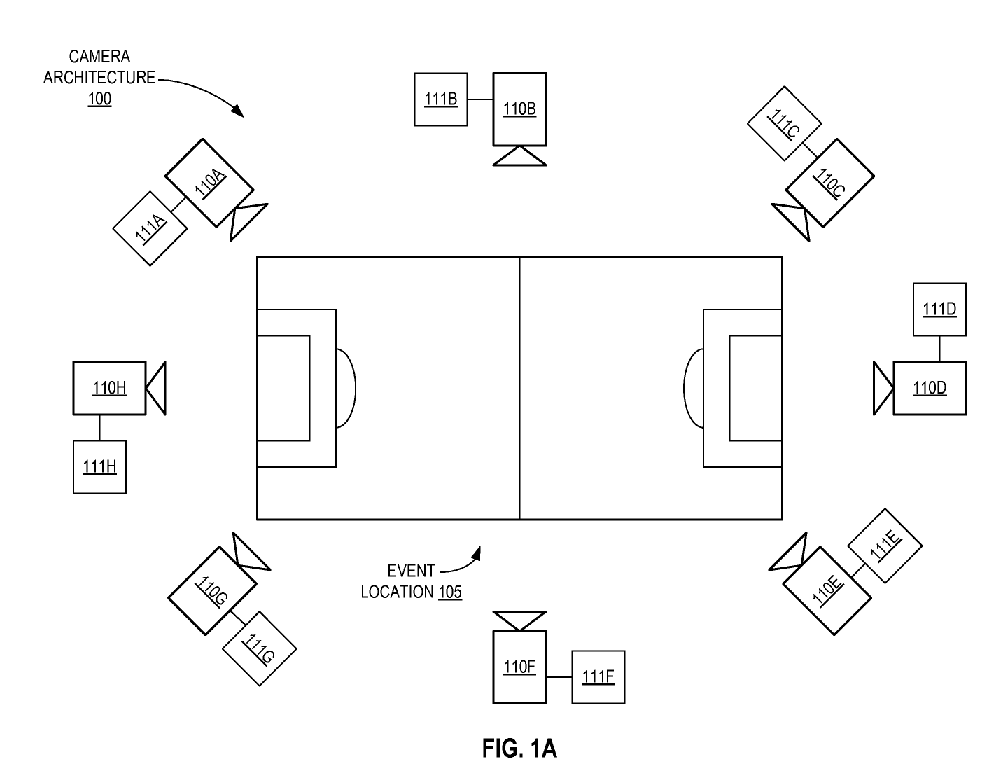

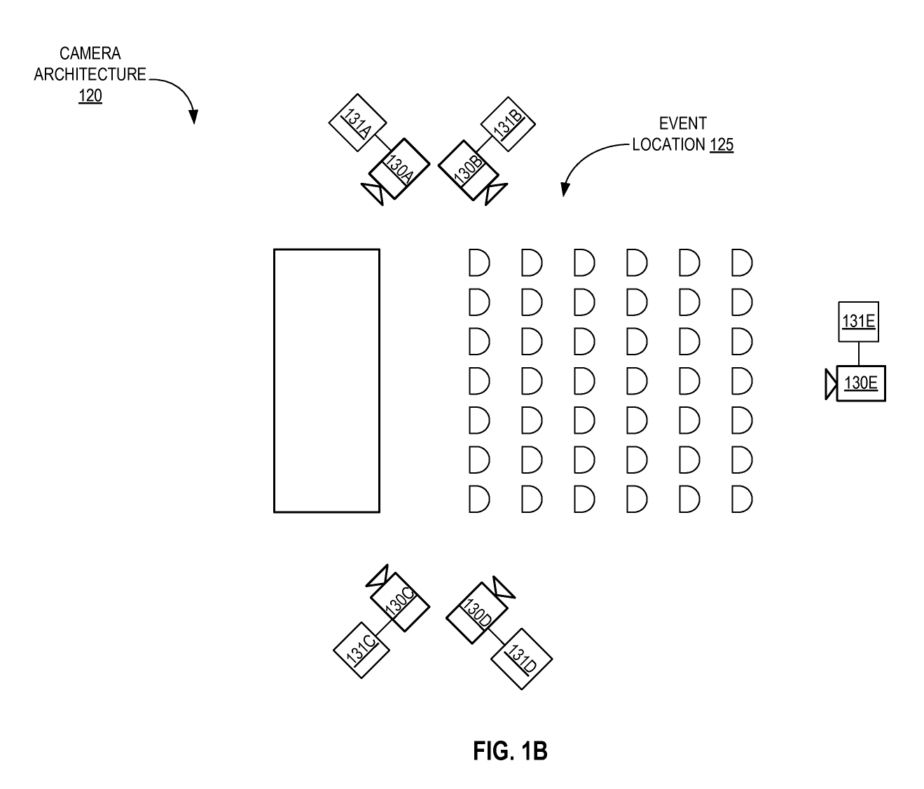

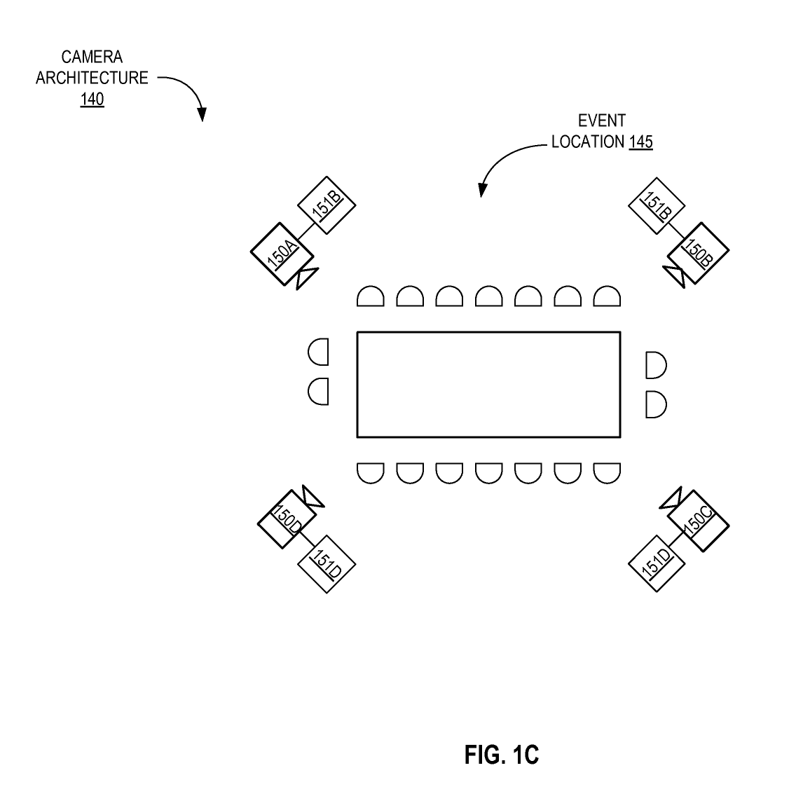

FIG. 1A is a block diagram illustrating an example camera architecture 100, in accordance with one embodiment of the present disclosure. In one embodiment, the camera architecture 100 may capture (e.g., take) videos and/or sequences of images of an event that occurs at the event location 105. For example, the camera architecture 100 may capture videos and/or images of a soccer game that occurs at the event location 105. In other examples, the camera architectures 100 may capture videos and/or images of a basketball game, a football game, a baseball game, a hockey game, etc. Any type of event may take place in event location 105. In other embodiments the event and/or event location 105 may be any shape (e.g., circular, oval, rectangular, square, irregular shapes, etc.).

The camera architecture 100 includes cameras 110A through 110H positioned around and/or within the event location 105. The cameras 110A through 110H may be devices that are capable of capturing and/or generating (e.g., taking) images (e.g., pictures) and/or videos (e.g., a sequence of images) of the event location 105. For example, the cameras 110A through 110H may include, but are not limited to, digital cameras, digital video recorders, camcorders, smartphones, webcams, tablet computers, etc. In one embodiment, the cameras 110A through 110H may capture video and/or images of an event location 105 (e.g., of an event at the event location 105) at a certain speed and/or rate. For example, the cameras 110A through 110H may capture multiple images of the event location 105 at a rate of one hundred images or frames per second (FPS) or at thirty FPS. The cameras 110A through 110H may be digital cameras or may be film cameras (e.g., cameras that capture images and/or video on physical film). The images and/or videos captured and/or generated by the cameras 110A through 110H may be in a variety of formats including, but not limited to, moving picture experts group format, MPEG-4 (MP4) format, DivX® format, Flash® format, a QuickTime® format, an audio visual interleave (AVI) format, a Windows Media Video (WMV) format, an H.264 (h264, AVC) format, a Joint Picture Experts Group (JPEG) format, a bitmap (BMP) format, a graphics interchange format (GIF), a Portable Network Graphics (PNG) format, etc. In one embodiment, the images (e.g., arrays of images or image arrays) and/or videos captured by one or more of the cameras 110A through 110H may be stored in a data store such as memory (e.g., random access memory), a disk drive (e.g., a hard disk drive or a flash disk drive), and/or a database.

In one example, camera 110A is positioned at the top left corner of event location 105, camera 110B is positioned at the top edge of the event location 105, camera 110C is positioned at the top right corner of the event location 105, camera 110D is positioned at the right edge of the event location 105, camera 110E is positioned at the bottom right corner of the event location 105, camera 110F is positioned at the bottom edge of the event location 105, camera 110G is positioned at the bottom left corner of the event location 105, and camera 110H is positioned at the left edge of the event location 105. Each of the cameras 110A through 110H is located at a position which provides each camera 110A through 110H with a particular viewpoint of the event location 105. For example, if a sporting event (e.g., a soccer game) occurs at the event location 105, camera 110B is located in a position that has a viewpoint of the event location 105 from one of the sidelines. Although eight cameras (e.g., cameras 110A through 110H) are illustrated in FIG. 1A, it should be understood that in other embodiments, any number of cameras may be included in the camera architecture 100. For example, the camera architecture 100 may include twenty cameras or fifty cameras. In other embodiments, the positions of the cameras (and thus the viewpoints of the event location 105 for the cameras) may vary. For example, the cameras 110A through 110H may be arranged around the event location 105 in a variety of different layouts and/or positions (e.g., two cameras along each edge of the event location 105) and/or at least some of the cameras 110A through 110H may be positioned within the event location (e.g., a camera may be held/worn by a participant of the event).

As illustrated in FIG. 1A, each of the cameras 110A through 110H is in communication with (e.g., directly coupled to and/or communicatively coupled via one or more networks to) a corresponding computing device 111A through 111H. For example, camera 110A is coupled to computing device 111A, camera 110B is coupled to computing device 111B, etc. In one embodiment, multiple cameras may be coupled to a single computing device. For example, cameras 110A and 110B may be coupled to a single computing device (not shown in the figure). In some implementations, any of the cameras 110A through 110H may communicate with a computing device via a network (e.g., a WiFi connection). In addition, in some implementations, the architecture 100 may also include microphones (which may be part of cameras 110 or computing devices 111, or be independent devices), wearable computers (e.g., computerized watches or eye glasses worn by participants of the event), inertial measurement units (IMUs) and the like. These devices may generate audio and/or positioning data (e.g., rate of acceleration, velocity, etc.) and communicate it to computing devices 111.

In one embodiment, the operation of the cameras 110A through 110H may be synchronized with each other and the cameras 110A through 110H may capture images and/or videos of the event location 105 in a synchronized and/or coordinated manner (e.g., the videos captured by the cameras 110A through 110H may be synchronized in time). For example, each of the cameras 110A through 110H may capture images and/or videos at a rate of thirty frames/images per second. Each of the cameras 110A through 110H may capture the images and/or videos of the event location 105 (e.g., of an event at the event location) at the same (or substantially the same) point in time. For example, if the cameras 110A through 110H start capturing images at the same time (e.g., time T or at zero seconds), the cameras 110A through 110H may each capture a first image of the event location 105 at time T+1 (e.g., at 1/30 of a second), a second image of the event location 105 at time T+2 (e.g., at 2/30 of a second), a third image of the event location 105 at time T+3 (e.g., at 3/30 of a second), etc.

Each computing device 111A through 111H may analyze and/or process the images and/or videos captured by a corresponding camera that is coupled to a computing device. In addition, the computing device may analyze audio and/or positioning data produced by microphones, wearable computers and/or IMUs. The computing device may analyze and/or process the images, videos, audio and/or positioning data to identify interesting portions of the images and/or videos. An interesting portion of a video and/or image may be a portion of a captured event that may depict objects, persons, and/or scenes that may be of interest to a viewer and/or a participant of the event at the event location 105. In one embodiment, the interesting portion of the video and/or image may include one or more images and/or frames and may be associated with and/or depict a certain time period in the event at the event location 105. For example, if the event is a soccer game, an interesting portion may depict the scoring of a goal that occurred at a certain time period. In another embodiment, the interesting portion may be a spatial portion of the video and/or image. For example, a video and/or image may depict the event from a certain viewpoint (e.g., from the bottom left corner of the event location 105). An interesting portion of the video may be a portion of a viewpoint depicted in the portion of the video. For example, the interesting portion may be a bottom left-hand corner of the viewpoint depicted in the portion of the video. Alternatively, an interesting portion of the video may be a portion having specific audio characteristics and/or specific characteristics related to positioning/motion of event participants.

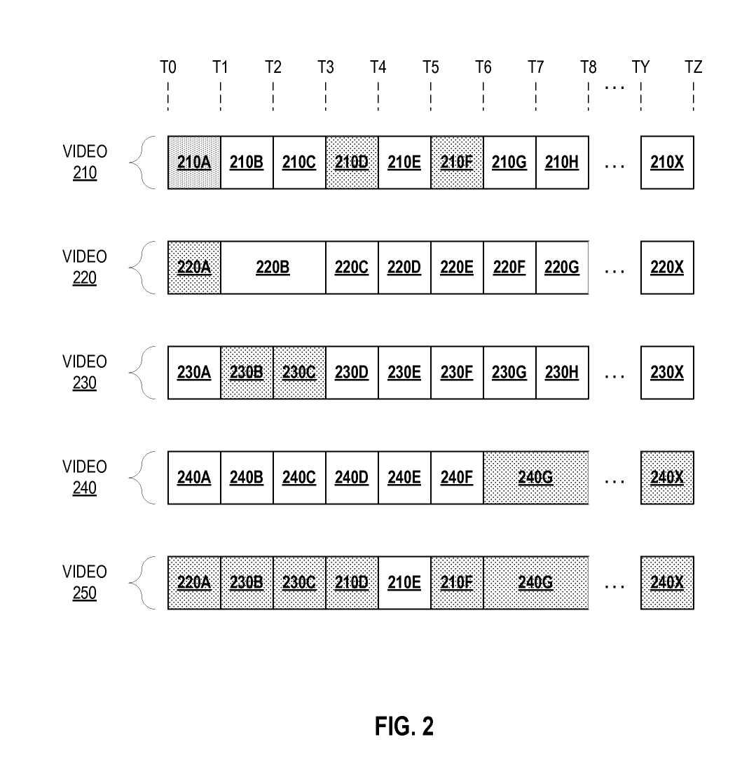

In one embodiment, the computing device may analyze the videos and/or images received from one or more cameras to identify the motions of one or more objects and/or people depicted in the videos and/or images. The computing device may determine that a portion of a video and/or image is interesting (e.g., may be of interest to a viewer or participant) based on the motion of one or more objects and/or people depicted in the video and/or image. For example, if the event is a soccer game, the computing device may determine that a portion of a video that depicts players (e.g., people) running (e.g., movement or motion) is an interesting portion. The identification of the motions of one or more objects and/or people depicted in the videos and/or images is discussed in more detail below in conjunction with FIGS. 2-6.

In another embodiment, the computing device may analyze videos and/or images received from one or more cameras to determine whether people are depicted in the videos and/or images. The computing device may determine that a portion of a video and/or image is interesting (e.g., may be of interest to a viewer) based on whether one or more people are depicted in the videos and/or images. For example, if players in the event location 105 are on the left side of the event location 105 at a certain time, a portion of the video captured by camera 110C may not depict any players at the certain time. The computing device may determine that the portion of the video captured by camera 110C is not interesting (e.g., is not a interesting portion). The computing device may determine that a portion of a video captured by camera 110G at the certain time is an interesting portion because the camera 110G may depict one or more players on the left side of the event location 105. The identification of the people depicted in the videos and/or images is discussed in more detail below in conjunction with FIGS. 2-6.

In one embodiment, the computing device may analyze videos and/or images received from one or more cameras to determine whether one or more objects are depicted in the videos and/or images. For example, if the event is a soccer game, the computing device may analyze the videos and/or images received from one or more cameras to determine whether portions of the videos and/or images depict a soccer ball (e.g., an object). The computing device may determine that portions of the videos and/or images that depict the soccer ball are interesting portions of the videos and/or images. The identification of objects depicted in the videos and/or images is discussed in more detail below in conjunction with FIGS. 2-6.

In another embodiment, the computing device may analyze videos and/or images received from one or more cameras to determine a location where one or more participants and/or people in an audience at the event location 105, are looking. For example, the computing device may analyze the faces of participants and/or people in the audience of a soccer game at the event location 105 and may determine that the participants and/or the members of the audience are looking at the bottom left corner of the event location 105 at a certain time in the soccer game. The computing device may determine that the portion of the video captured by the camera 110G at the certain time is an interesting portion. The identification of locations where participants and/or people in an audience are looking is discussed in more detail below in conjunction with FIGS. 2-6.

In some embodiments, the computing device may analyze videos and/or images received from one or more cameras to not just identify generally interesting portions but to identify portions that are of interest to a specific viewer or a specific participant of an event. For example, if a viewer of a soccer game is a parent of one of the soccer players, then an interesting portion for the parent may be the portion containing their child. In such embodiments, the computing device may analyze videos and/or images received from one or more cameras to determine whether a certain person (e.g., a child of a viewer) is depicted in the videos and/or images. The computing device may determine that a portion of a video and/or image is interesting to a viewer or a participant based on whether a certain person (e.g., a child of a viewer of a soccer game) or a certain object (e.g., a painting of an artist viewing an art exhibit event) is depicted in the videos and/or images. In addition or alternatively, the computing device may determine a location where a specific participants or a specific viewer of the event is looking.

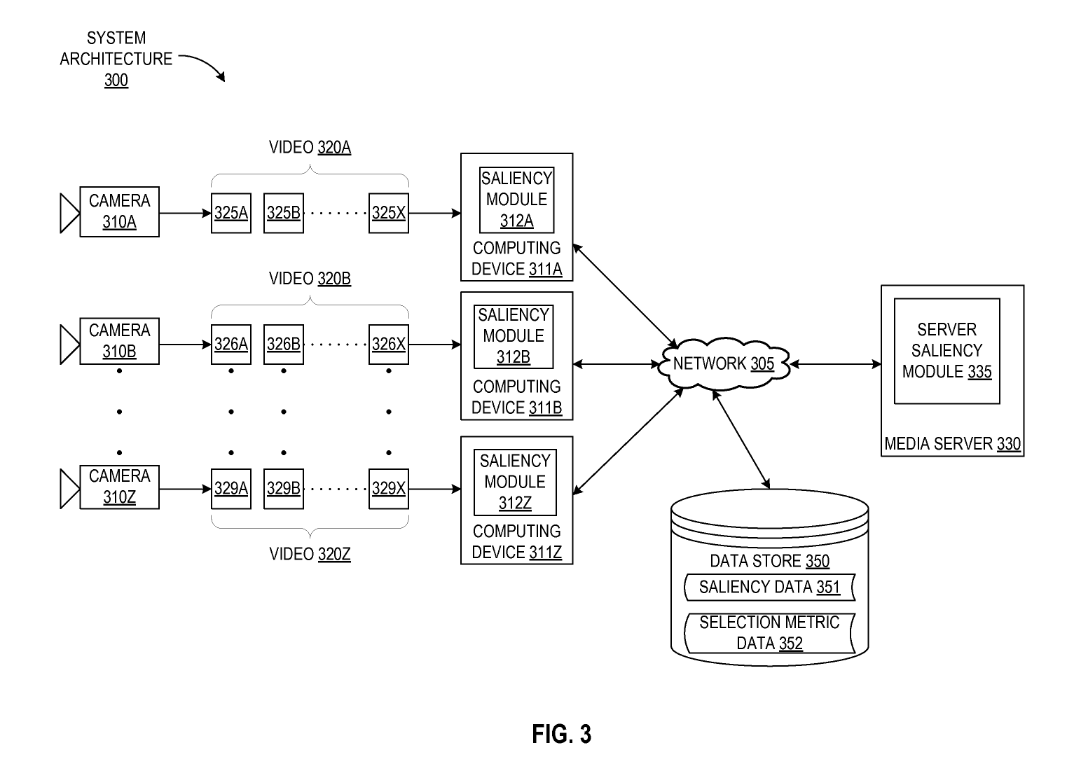

In one embodiment, a server computing device (as illustrated and discussed below in conjunction with FIG. 3) may also receive videos and/or images captured by the cameras 110A through 110H. The server computing device may perform additional processing and/or analysis of the videos captured by the cameras 110A through 110H to identify additional interesting portions and/or may determine that a portion that was identified as interesting may not be interesting. For example, the computing device 111H may identify a portion of the video captured by the camera 110H as interesting. The server computing device may determine that the identified portion may not be interesting. In another example, the server computing device may identify a portion of the video captured by camera 110H as an interesting portion even though the computing device 111H did not identify the portion as an interesting portion. In another embodiment, the computing devices 111A through 111H may not analyze and/or process the images and/or videos captured by the cameras 110A through 110H. Instead, the computing devices 111A through 111H may provide the videos captured by the cameras 110A through 110H to the server computing device for analysis and/or processing.

In one embodiment, the server computing device may generate a content item (e.g., a digital video) based on the interesting portions of the videos captured by the cameras 110A through 110H. As discussed above, the interesting portions of the videos may be identified by computing devices 111A through 111H and/or by the server computing device. The server computing device may analyze the interesting portions of the videos and may combine one or more of the interesting portions of the videos to generate a content time. In one embodiment, the interesting portions that are combined to generate the content item may not overlap in time. For example, as discussed above, the cameras 110A through 110H may capture videos of the event that are synchronized in time and interesting portions of the videos may be identified. The server computing device may select interesting portions from the videos such that the selected interesting portions are non-overlapping. For periods of time where no interesting portions have been identified in the videos (e.g., during a timeout in a soccer game, during an intermission, etc.) the server computing device may identify non-interesting portions from the videos that depict the event during the periods of time. The server may combine one or more interesting portions and/or non-interesting portions to generate the content item. This may allow the server computing device to generate a content item that provides a continuous view of the event without gaps in the periods of time of the event and without portions that overlap in time. The generated content item can be an after-the-fact summarization or distillation of important moments in the event as determined during or after the event or it may be a real-time view of the summary of the important moments in the event as determined in real-time during the event. Content items generated after the fact and in real-time can be substantially different even when they pertain to the same event. Generation of the content item based on the interesting portions of the videos identified by the computing device and/or server computing device is discussed in more detail below in conjunction with FIGS. 2-6.

In one embodiment, the server computing device may use one or more metrics, criterion, conditions, rules, etc., when selecting interesting portions from the videos to be used to generate the content item. For example, the server computing device may select interesting portions that are from videos captured by cameras that are less than a threshold distance apart from each other. In another example, the server computing device may select interesting portions that are longer than a minimum length. The one or more metrics, criterion, conditions, rules, etc., used to select interesting portions from the videos that are used to generate the content item may be referred to as selection metrics.

In one embodiment, the content item generated by the server computing device may be a summary video. The length of the summary video may be shorter than the length of the event. The summary video may present a subset of the interesting portions to provide the viewer of the summary video with a recap or summary focusing on specific people, objects, and/or occurrences that are depicted in the videos of the event. For example, if the event is a soccer game, the summary video may include portions of the video that depict the scoring of a goal.

In one embodiment, the cameras 110A through 110H may capture the videos of the event and/or event location 105 in real time or near real time. For example, the cameras 110A through 110H may provide the captured video (e.g., video stream) to a media server as the event takes place in the event location (e.g., as at least a portion of the event is still occurring). The server computing device and/or the computing devices 111A through 111H may analyze and/or process the videos generated by the cameras 110A through 110H in real time or near real time to identify interesting portions of the videos. The server computing device and/or the computing devices may also generate a content item (e.g., a digital video) in real time based on the identified interesting portions (e.g., generating a content item by splicing together and/or combining one or more of the identified interesting portions). For example, if the event is a live sports game, the content item may be generated in real time so that the content item (e.g., the video of the interesting portions of the sports game) may be broadcast live.

FIG. 1B is a block diagram illustrating an example camera architecture 120, in accordance with another embodiment of the present disclosure. In one embodiment, the camera architecture 120 may capture (e.g., take) videos and/or sequences of images of an event that occurs at the event location 125. In other embodiments the event and/or event location 125 may be any shape (e.g., circular, oval, rectangular, square, irregular shapes, etc.). The camera architecture 120 includes cameras 130A through 130E positioned around the event location. The cameras 130A through 130E may be devices that are capable of capturing and/or generating images and/or videos of the event location 125 at a certain speed and/or rate. The images and/or videos captured and/or generated by the cameras 130A through 130E may be in a variety of formats.

Cameras 130A through 130E are positioned in various locations in the event location 125 that provide each camera 130A through 130E with a particular viewpoint of the event location 125. In one embodiment, the operation of the cameras 130A through 130E may be synchronized with each other and the cameras 130A through 130E may capture images and/or videos of the event location 125 in a synchronized and/or coordinated manner (e.g., the videos captured by the cameras 130A through 130E may be synchronized in time). Although five cameras (e.g., cameras 130A through 130E) are illustrated in FIG. 1B, it should be understood that in other embodiments, any number of cameras may be included in the camera architecture 120. In other embodiments, the positions of the cameras (and thus the viewpoints of the event location for the cameras) may vary. As illustrated in FIG. 1B, each of the cameras 130A through 130E is in communication with (e.g., directly coupled to and/or communicatively coupled via one or more networks to) a corresponding computing device 131A through 130E. In one embodiment, multiple cameras may be coupled to a single computing device.

Each computing device 131A through 131E may analyze and/or process the images and/or videos captured by cameras that are coupled to a computing device to identify interesting portions (e.g., a portion of the video that may depict objects, persons, scenes, and/or events that may be of interest to a viewer of the event at the event location 125) of the images and/or videos. In one embodiment, the interesting portion of the video and/or image may include one or more images and/or frames and may be associated with and/or depict a certain time period in the event at the event location 125. In another embodiment, the interesting portion may be a spatial portion of the video and/or image (e.g., a portion of the viewpoint of the video and/or image).

In one embodiment, the computing device may determine that a portion of a video and/or image is interesting (e.g., may be of interest to a viewer and/or participant of an event) based on the motion of one or more objects and/or people depicted in the video and/or image. In another embodiment, the computing device may determine that a portion of a video and/or image is interesting (e.g., may be of interest to a viewer and/or a participant) based on whether one or more persons are depicted in the videos and/or images. In a further embodiment, the computing device may analyze videos and/or images received from one or more cameras to determine whether one or more objects are depicted in the videos and/or images. In one embodiment, the computing device may determine that a portion of a video is interesting based on a location where one or more participants and/or people in an audience at the event location 125, are looking.

In one embodiment, a server computing device (as illustrated and discussed below in conjunction with FIGS. 2-6) may perform additional processing and/or analysis of the videos to identify additional interesting portions and/or may determine that a portion that was identified as interesting may not be interesting. In another embodiment, the computing devices 131A through 131E may provide the videos and/or videos captured by the cameras 130A through 130E to the server computing device for analysis and/or processing to identify interesting portions. In one embodiment, the server computing device may generate a content item (e.g., a digital video) based on the interesting portions of the videos captured by the cameras 130A through 130E. In another embodiment, the server computing device may use selection metrics to identify interesting portions of videos that may be used to generate the content item. In one embodiment, the content item generated by the server computing device may be summary video. In one embodiment, the cameras 130A through 130E may capture the videos of the event and/or event location 125 in real time or near real time. The server computing device and/or the computing devices 131A through 131E may analyze and/or process the videos generated by the cameras 130A through 130E in real time or near real time to identify interesting portions of the videos. The server computing device and/or the computing devices may also generate a content item (e.g., a digital video) in real time or near real time.

FIG. 1C is a block diagram illustrating an example camera architecture 140, in accordance with a further embodiment of the present disclosure. In one embodiment, the camera architecture 140 may capture (e.g., take) videos and/or sequences of images of an event that occurs at the event location 145. For example, the camera architecture 140 may capture videos and/or images of a conference, debate, a press release and/or a political event that occurs at the event location 145. In other embodiments the event and/or event location 145 may be any shape (e.g., circular, oval, rectangular, square, irregular shapes, etc.).

The camera architecture 140 includes cameras 150A through 150D positioned around the event location. The cameras 150A through 150D may be devices that are capable of capturing and/or generating images and/or videos of the event location 145. In one embodiment, the cameras 150A through 150D may capture video and/or images of an event location 145 (e.g., of an event at the event location) at a certain speed and/or rate. The images and/or videos captured and/or generated by the cameras 150A through 150D may be in a variety of formats. In one embodiment, the images and/or videos capture by one or more of the cameras 150A through 150D may be stored in a data store.

Cameras 150A through 150D are positioned in various locations in the event location 145 that provide each camera 150A through 150D with a particular viewpoint of the event location 145. In one embodiment, the operation of the cameras 150A through 150D may be synchronized with each other and the cameras 150A through 150D may capture images and/or videos of the event location 145 in a synchronized and/or coordinated manner (e.g., the videos captured by the cameras 150A through 150D may be synchronized in time). Although four cameras (e.g., cameras 150A through 150D) are illustrated in FIG. 1C, it should be understood that in other embodiments, any number of cameras may be included in the camera architecture 140. In other embodiments, the positions of the cameras (and thus the viewpoints of the event location for the cameras) may vary. As illustrated in FIG. 1C, each of the cameras 150A through 150D is in communication with (e.g., directly coupled to and/or communicatively coupled via one or more networks to) a corresponding computing device 151A through 151D. In one embodiment, multiple cameras may be coupled to a single computing device.

Each computing device 151A through 151D may analyze and/or process the images and/or videos captured by cameras that are coupled to a computing device to identify interesting portions (e.g., a portion of the video that may depict objects, persons, scenes, and/or events that may be of interest to a viewer of the event at the event location 145) of the images and/or videos. In one embodiment, the interesting portion of the video and/or image may include one or more images and/or frames and may be associated with and/or depict a certain time period in the event at the event location 145. In another embodiment, the interesting portion may be a spatial portion of the video and/or image (e.g., a portion of a viewpoint of the video and/or image).

In one embodiment, the computing device may determine that a portion of a video and/or image is interesting (e.g., may be of interest to a viewer and/or participant of an event) based on the motion of one or more objects and/or people depicted in the video and/or image. In another embodiment, the computing device may determine that a portion of a video and/or image is interesting (e.g., may be of interest to a viewer and/or participant of an event) based on whether one or more persons are depicted in the videos and/or images. In a further embodiment, the computing device may analyze videos and/or images received from one or more cameras to determine whether one or more objects are depicted in the videos and/or images. In one embodiment, the computing device may determine that a portion of a video is interesting based on a location where one or more participants and/or people in an audience at the event location 145, are looking.

In one embodiment, a server computing device (as illustrated and discussed below in conjunction with FIGS. 2-6) may perform additional processing and/or analysis of the videos to identify additional interesting portions and/or may determine that a portion that was identified as interesting may not be interesting. In another embodiment, the computing devices 151A through 151D may not analyze and/or process the videos and/or videos captured by the cameras 150A through 150D. Instead, the computing devices 151A through 151D may provide the videos and/or videos captured by the cameras 150A through 150D to the server computing device for analysis and/or processing. In one embodiment, the server computing device may generate a content item (e.g., a digital video) based on the interesting portions of the videos captured by the cameras 150A through 150D. In another embodiment, the server computing device may use selection metrics to identify interesting portions of videos that may be used to generate the content item. In one embodiment, the content item generated by the server computing device may be summary video. In one embodiment, the cameras 150A through 150D may capture the videos of the event and/or event location 145 in real time or near real time. The server computing device and/or the computing devices 151A through 151D may analyze and/or process the videos generated by the cameras 150A through 150D in real time or near real time to identify interesting portions of the videos. The server computing device and/or the computing devices may also generate a content item (e.g., a digital video) in real time or near real time.

FIG. 2 is a block diagram illustrating example videos 210, 220, 230, and 240, in accordance with one embodiment of the present disclosure. As discussed above, cameras may capture, generate, and/or obtain videos of an event (e.g., a sports game, a concert, a presentation, etc.) at an event location (e.g., event locations 105, 125, and 135 as illustrated in FIGS. 1A through 1C). For example, a first camera may capture and/or generate video 210, a second camera may capture and/or generate video 220, a third camera may capture and/or generate video 230, and a fourth camera may capture and/or generate video 240. Each of the videos 210, 220, 230, and 240 includes multiple portions. For example, video 210 includes portions 210A through 210X, video 220 includes portions 220A through 220X, etc. Each portion may include one or more images and/or frames. As illustrated in FIG. 2, each of the portions may be of different sizes and/or lengths. Each of the portions of the videos 210, 220, 230, and 240 are associated with certain periods of time in the event. For example, portion 230A is associated with the time period between time T0 and T1 (e.g., may depict the event from the time T0 to T1). In another example, portion 240G is associated with the time period between T6 and T8 (e.g., may depict the event from time T6 to T8). In a further example, the portion 240X is associated with the time period between time TY and TZ (e.g., may depict the event from the time TY to TZ).

As discussed above, a computing device and/or a server computing device may analyze videos 210, 220, 230, and 240 to identify interesting portions of the videos. For example, a computing device and/or a server computing device may analyze the video 210 and determine that portions 210D and 210F are interesting portions. In another example, a computing device and/or a server computing device may analyze the video 220 and may determine that portion 220A is an interesting portion. The interesting portions of the videos 210, 220, 230, and/or 240 are indicated using shaded boxes.

Also as discussed above, a server computing device may analyze and/or process the interesting portions of the videos 210, 220, 230, and/or 240 to generate video 250 (e.g., a content item) based on the interesting portions. The server computing device may identify a subset of the interesting portions of the videos 210, 220, 230, and/or 240 and may generate the video 250 based on the subset of the interesting portions of the videos 210, 220, 230, and/or 240. For example, the server computing device may identify a subset of the interesting portions 210A, 210D, 210F, 220A, 230B, 230C, 240G, and 240X and may generate the video 250 based on the subset.

The server computing device may use one or more selection metrics when selecting interesting portions from the videos to be used to generate the content item. In one embodiment, the server computing device may select interesting portions that are from videos captured by cameras that are less than a threshold distance apart from each other (e.g., camera that are at most two positions to the right or left of each other). This may help prevent the video 250 from depicting a viewpoint that is far away from a previous viewpoint and may reduce the amount of disorientation experienced by a viewer when transitioning to different viewpoints. In another embodiment, the server computing device may select interesting portions that are longer than a minimum length. For example, the server computing device may select interesting portions that are longer than 20 seconds. This may allow the video 250 to depict different viewpoints of the event without constantly transitioning to different viewpoints (and possibly disorienting a viewer). In one embodiment, the server computing device may select interesting portions that are less than a maximum length. For example the server computing device may select interesting portions that are less than 60 seconds long. This may allow the video 250 to depict different viewpoints of the event without depicting a particular viewpoint for too long (and possibly boring a viewer). In another embodiment, the server computing device may select cameras which show content more than a given distance apart in order to make the transition between cameras obvious to the viewer. In yet another embodiment, the server computing device may select a camera which was close to the content location at a previous time to show an instant replay.

In one embodiment, multiple interesting portions that are associated with the same period of time may be identified. For example, as illustrated in FIG. 2, portions 210A and 220A are identified as interesting portions. Portions 210A and 220A are both associated with the time period starting at time T0 and ending at time T1. In one embodiment, when multiple interesting portions are associated with the same period of time (e.g., same time period), the server computing device may select one of the multiple interesting portions based on a saliency (interest) score associated with each of the multiple interesting portions. For example, when a computing device and/or server computing device identifies a portion of a video as interesting, the computing device and/or server computing device may generate, obtain, determine, and/or calculate a saliency score for the portion of the video. The server computing device may use the saliency score for the interesting portions as a selection metric to identify one of the interesting portions 210A and 220A to include in the video 250.

In one embodiment, the server computing device may determine that the videos 210, 220, 230, and 240 do not include one or more interesting portions for a period of time. For example, as illustrated in FIG. 2, the videos 210, 220, 230, and 240 do not include one or more interesting portions for the time period between time T4 and time T5. The server computing device may identify a non-interesting portion for the time period between time T4 and time T5 to include in the video 250 so that the video 250 can continuously depict the event without gaps in time. In one embodiment, the server computing device may also use selection metrics when identifying non-interesting portions to include in the video 250. For example, the server computing device may identify a non-interesting portion that are from videos captured by cameras that are less than a threshold distance apart from each other. As illustrated in FIG. 2, portion 210E is a non-interesting portion that is include in the video 250. The portion 210E may be included in the video 250 because the videos 210, 220, 230, and/or 240 do not include interesting portions for the time period between time T4 and T5.

FIG. 3 illustrates an example system architecture 300, in accordance with one embodiment of the present disclosure. The system architecture 300 includes cameras 310A through 310Z, computing devices 311A through 311Z, a data store 350, and a media server 330 coupled to a network 305. Network 305 may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computing devices (e.g., servers or server computers), and/or a combination thereof.

The cameras 310A through 310Z may be part of a camera architecture as illustrated in FIGS. 1A through 1C. The cameras 310A through 310Z may be positioned around an event location in various layouts and/or positions. Each of the cameras 310A through 310Z may be located at a position that provides each camera 310A through 310Z with a particular viewpoint of the event location. Cameras 310A through 310Z may generate videos 320A through 320Z, respectively. Each of the videos 320A through 320Z may include multiple portions and each portion may include multiple frames and/or images. For example, video 320A includes portions 325A through 325X, video 320B includes portions 326A through 326X, etc.

As illustrated in FIG. 3, cameras 310A through 310Z are coupled to computing devices 311A through 311Z, respectively. Examples of computing device include, but are not limited to, personal computers (PCs), laptops, mobile phones, smart phones, tablet computers, netbook computers etc. Computing devices 311A through 311Z include saliency modules 312A through 312Z, respectively. The saliency modules 312A through 312Z may analyze and/or process the videos 320A through 320Z, respectively, to identify interesting portions of the videos 320A through 320Z. For example, saliency module 312A may process video 320A to identify interesting portions of the video 320A. In one embodiment, multiple cameras may be coupled to a single computing device (not shown in the figures) and the saliency module on the single computing device may process and/or analyze the videos and/or images captured by the multiple cameras to identify interesting portions. In some implementations, the architecture 300 may include microphones, wearable computers and/or IMUs that generate audio and/or positioning data, which can also be used by the saliency modules to identify interesting portions. microphones, wearable computers and/or IMUs

In one embodiment, the saliency modules 312A through 312Z may determine saliency scores for one or more of the portions of the videos 320A through 320Z. A saliency score may be any numerical value, alphanumeric value, text, string, and/or other data indicative of whether a portion of the videos 320A through 320Z is interesting and/or a level of interest for the portion of the videos 320A through 320Z (e.g., how interesting a portion of the video is). For example, a saliency score for portion of a video above a certain threshold may indicate that the portion of the video is interesting and the value of the saliency score may indicate the level of interest for the portion of the video (e.g., the higher the saliency score, the more interesting the portion of the video). A saliency score may be based on one or more of the people depicted in the videos 320A through 320Z, the objects depicted in the videos 320A through 320Z, the motion of objects and/or people in the videos 320A through 320Z, and locations where people in the videos 320A through 320Z are looking.

In one embodiment, the saliency modules 312A through 312Z may analyze and/or process respective videos 320A through 320Z to identify the motion of one or more objects and/or people depicted in the videos 320A through 320Z. The saliency modules 312A through 312Z may determine that a portion of a video and/or image is interesting (e.g., may be of interest to a viewer or participant) based on the motion of one or more objects and/or people depicted in the video and/or image.

In one embodiment, the saliency modules 312A through 312Z may identify foreground motion in the videos 320A through 320Z. For example, if the camera 310A is also moving in addition to the people or objects in the event (e.g., the camera 310A is being panned left/right or tilted up/down by a person operating the camera 310A), the saliency module 312A may determine the foreground motion to identify the moving objects and/or people. In one embodiment, the saliency modules 312A through 312Z may determine the foreground motion by tracking features points across frames and/or images of the videos 320A through 320Z. Feature points may be objects, people, and/or other items depicted in a portion of video (e.g., in one or more frames/images) that are also present a previous portion of the video (e.g., in a previous frame/image). The motion of a camera may be determined by identifying feature points across portions (e.g., across frames/images) of the video. For example, a goal post, a building, etc., may be identified as a feature point. The movement of the feature points may be used to determine the direction and/or velocity of the motion of the camera. The saliency modules 312A through 312Z may filter out the movement of the camera when analyzing and/or processing the videos 320A through 320Z. The saliency modules 312A through 312Z may identify objects and/or people in the foreground of the videos 320A through 320Z after filtering out (e.g., subtracting out) the movement of the camera. This may allow the saliency modules 312A through 312Z to better determine the motion of the objects and/or people depicted in the videos 320A through 320Z.

Various motion detection methods, operations, algorithms, functions, techniques, etc., may be used to determine the motion of the objects and/or people in the foreground of the videos 320A through 320Z. For example, one or more clustering algorithms (e.g., connection based clustering algorithms, centroid based clustering algorithms, distribution based clustering algorithms, density based clustering algorithms, etc.) may be used to determine the motion of the objects and/or people in the videos 320A through 320Z. Other motion detection techniques may include matching low-level features such as edges or corners in multiple frames and detecting a change in position, matching objects (such as people, ball, etc.) in multiple frames and detecting a change in position, tracking objects or low-level features across frames using techniques such as a particle filter, density estimation, or exhaustive search, building a model of the “normal” or “background” appearance of a scene over time and then detecting that a part of the scene has recently changed, instrumenting people or objects in the event (e.g. players, ball) with instruments capable of measuring a change in position, such as an inertial measurement unit (IMU), etc.

In one embodiment, the saliency modules 312A through 312Z may determine whether a portion of a video is interesting based on the amount of movement of the people and/or objects in the portion of the video. For example, if there is little movement in a portion of the video, the saliency score for the portion of the video may be lower (indicating that the portion of the video is not interesting). In another example, if there is motion across a larger portion of the viewpoint depicted in a portion of a video, the saliency score for the portion of the video may be higher (indicating that the portion of the video is interesting).

In another embodiment, the saliency modules 312A through 312Z may analyze videos and/or images captured by the cameras 310A through 310Z to determine whether people are depicted in the videos and/or images. The saliency modules 312A through 312Z may determine that a portion of a video and/or image is interesting (e.g., may be of interest to a viewer and/or participant) based on whether one or more people are depicted in the videos and/or images. For example, if the event is a lecture or a presentation, the saliency modules 312A through 312Z may determine that portions of the videos 320A through 320Z are interesting if the lecturers or presenters (e.g., people) are depicted in the portions of the videos 320A through 320Z. In another example, if the event is a sporting event (e.g., a soccer game, a baseball game, a football game, etc.), the saliency modules 312A through 312Z may determine that portions of the videos 320A through 320Z are interesting if one or more players in the sporting event are depicted in the videos 320A through 320Z.

The saliency modules 312A through 312Z may identify people depicted in the videos 320A through 320Z using various methods, operations, algorithms, functions, techniques, etc. For example, the saliency modules 312A through 312Z may identify faces of people depicted in the videos 320A through 320Z using various facial detection algorithms. In another example, the saliency modules 312A through 312Z may use a deformable parts model (DPM) for identifying people depicted in the videos 320A through 320Z. In a further example, the saliency modules 312A through 312Z may use a Markov chain Monte Carlo algorithm to identify people depicted in the videos 320A through 320A. In yet another example, the saliency modules 312A through 312Z may use a Histogram of Oriented Gradients (HOG) detector to identify people depicted in the videos 320A through 320A. In still another example, the saliency modules 312A through 312Z may use silhouette-based techniques to identify people depicted in the videos 320A through 320A. It should be noticed that various other techniques or any combination of he above techniques can be used to identify people depicted in the videos 320A through 320A. g

In one embodiment, the saliency modules 312A through 312Z may determine that a portion of a video is interesting based on the people depicted in the portion of the video. For example, if there are a smaller number of people depicted in a portion of the video, the saliency score for the portion of the video may be lower (indicating that the portion of the video is not interesting). In another example, if a saliency module is able to detect faces of people in the portion of the video, the saliency score for the portion of the video may be higher (indicating that the portion of the video is interesting).

In one embodiment, the saliency modules 312A through 312Z may analyze videos 320A through 320Z captured by the cameras 310A through 310Z to determine whether one or more objects are depicted in the videos 320A through 320Z. The saliency modules 312A through 312Z may determine that a portion of a video and/or image is interesting (e.g., may be of interest to a viewer) based on whether one or more objects are depicted in the videos and/or images. For example, if the event is a classical music concert, the saliency modules 312A through 312Z may determine that portions of the videos 320A through 320Z are interesting if one or more musical instruments (e.g., a violin, a flute, etc.) are depicted in the portions of the videos 320A through 320Z. In another example, if the event is a sporting event (e.g., a soccer game, a baseball game, a football game, etc.), the saliency modules 312A through 312Z may determine that portions of the videos 320A through 320Z are interesting if a ball (e.g., a football, a baseball, a soccer ball, etc.) is depicted in the portions of the videos 320A through 320Z.

The saliency modules 312A through 312Z may identify objects depicted in the videos 320A through 320Z using various methods, operations, algorithms, functions, techniques, etc. For example, the saliency modules 312A through 312Z may use a deformable parts model (DPM) for identifying objects depicted in the videos 320A through 320Z. In a further example, the saliency modules 312A through 312Z may use a particle filter (e.g., a density estimation algorithm) to identify objects depicted in the videos 320A through 320Z. In yet another example, the saliency modules 312A through 312Z may use a Markov chain Monte Carlo algorithm to identify objects depicted in the videos 320A through 320A. In still another example, the saliency modules 312A through 312Z may build a model of the “normal” or “background” appearance of a scene over time and then detect that a part of the scene has recently changed to identify objects depicted in the videos 320A through 320A. In yet another example, the saliency modules 312A through 312Z may extract features, match those features to similar features in a “dictionary”, and determine spatio-temporal patterns (such as the DPM model for detecting people) or spatio-temporal histograms (bag-of-words) of feature types to identify objects depicted in the videos 320A through 320A. In one embodiment, the saliency modules 312A through 312Z may identify one or more objects based on the type of the event. For example, if the event is a sports game, the saliency modules 312A through 312Z may identify certain objects (e.g., a ball, a goal post, home plate on a baseball field, etc.) and may determine that a portion of the video is interesting if the portion of the video depicts the objects. The type of the event may be classification of the subject matter, content, genre, etc. of the event. The saliency modules 312A through 312Z may determine the type of the event based on a location of the event, a schedule (e.g., a schedule of the user or of the event stored in a data store), and/or based on data provided to the system architecture 300 (e.g., based on data provided by an organization that is hosting the event). The saliency modules 312A through 312Z may also use knowledge about the event type and structure to identify interesting portions. For example, the saliency modules 312A through 312Z may use the rules of basketball to determine when something interesting happens during the basketball game captured in in the videos.

As discussed above, the saliency modules 312A through 312Z may determine that a portion of a video is interesting based on the objects depicted in the portion of the video. For example, if there are a larger number of objects depicted in a portion of the video, the saliency score for the portion of the video may be higher (indicating that the portion of the video is interesting). In another example, if a saliency module is able to detect certain objects (e.g., a soccer ball) in the portion of the video, the saliency score for the portion of the video may be higher (indicating that the portion of the video is interesting).

In another embodiment, saliency modules 312A through 312Z may analyze videos 320A through 320Z captured by the cameras 310A through 310Z to determine a location where one or more people in an audience at the event location, are looking. For example, the computing device may identify faces of people in the audience of an event depicted by the videos 320A through 320Z. The saliency modules 312A through 312Z may analyze the faces of the people in the audience to determine a location where the people in the audience are looking. A saliency module may determine that the person's face is turned to a certain direction based on the position of eyes, ears, nose, and/or mouth of person's face. For example, the saliency module may be able to determine a vector, or a line (e.g., a ray line) that originates from the person's face and indicates where the person is looking. The saliency module may identify a vector/line for each face depicted in a portion of a video. The saliency module may determine a location where multiple vectors/lines intersect and may determine that the location where the people in the audience are looking. The saliency module may determine that the portion of the video is interesting (may assign a higher saliency score to the portion of the video) if the portion of the video depicts the location where the people in the audience are looking.

The media server 330 may be one or more computing devices such as a rackmount server, a router computer, a server computer, a personal computer, a mainframe computer, a laptop computer, a tablet computer, a desktop computer, etc. The media server 330 includes a server saliency module 335. As discussed above, the server saliency module 335 may analyze videos 320A through 320Z to identify interesting portions of the videos (instead of or in addition to the saliency modules 312A through 312Z). For example, the saliency module 312A through 312Z may not analyze and/or process the videos 320A through 320Z and may provide the videos 320A through 320Z to the server saliency module 335. The server saliency module 335 may process and/or analyze the videos 320A through 320Z to identify interesting portions of the videos 320A through 320Z. In another example, the server saliency module 335 may perform additional processing and/or analysis of the videos to identify additional interesting portions and/or may determine that a portion that was identified as interesting may not be interesting. For example, saliency module 312B may identify a portion of a as interesting. The server saliency module 335 may determine that the identified portion may not be interesting. In another example, the server saliency module 335 may identify a portion of the video as a interesting portion even though the saliency module 312B did not identify the portion as a interesting portion.

In one embodiment, server saliency module 335 may analyze and/or process the interesting portions of the videos 320A through 320Z to generate a combined video (e.g., a content item) based on the interesting portions. The server saliency module 335 may identify a subset of the interesting portions of the videos 320A through 320Z and may generate the combined video based on the subset of the interesting portions of the videos 320A through 320Z (as discussed above in conjunction with FIG. 2). The server saliency module 335 may use one or more selection metrics when selecting interesting portions from the videos 320A through 320Z to be used to generate the combined content item. In one embodiment, the server saliency module may select interesting portions that are from videos captured by cameras that are less than a threshold distance apart from each other (as discussed above in conjunction with FIG. 2). In another embodiment, the server saliency module 335 may select interesting portions that are a longer than a minimum length (as discussed above in conjunction with FIG. 2). In one embodiment, the server saliency module 335 may select interesting portions that are a less than a maximum length (as discussed above in conjunction with FIG. 2). The server saliency module 335 may use the selection metric data 352 when selecting or identifying interesting portions. The selection metric data 352 may include values, thresholds, and/or other data that may be used by the server saliency module 335 to identify interesting portions to include in the combined video.

In one embodiment, multiple interesting portions that are associated with the same period of time may be identified. When multiple interesting portions are associated with the same period of time (e.g., same time period), the server saliency module 335 may select one of the multiple interesting portions based on a saliency score associated with each of the multiple interesting portions. For example, the server saliency module 335 may select the portion that has the highest saliency score when multiple interesting portions are associated with the same period of time. In another embodiment, the server saliency module 335 may determine that the videos 320A through 320Z do not include one or more interesting portions for a period of time. The server saliency module 335 may identify a non-interesting portion for the time period to include in the combined video so that the combined video can continuously depict the event without gaps in time (as discussed above in conjunction with FIG. 2). In one embodiment, the server saliency module 335 may also use selection metrics when identifying non-interesting portions to include in the video 250.

In one embodiment, the data store 350 may be may be a memory (e.g., random access memory), a cache, a drive (e.g., a hard drive), a flash drive, a database system, or another type of component or device capable of storing data. The data store 350 may also include multiple storage components (e.g., multiple drives or multiple databases) that may also span multiple computing devices (e.g., multiple server computers). In one embodiment, the data store 350 includes saliency data 351 and selection metric data 352. As discussed above, the selection metric data 352 may include values, thresholds, and/or any other data that may be used by the server saliency module 335 to identify interesting portions to include in the combined video. The saliency data 351 may include data that may be used to identify interesting portions of the videos 320A through 320Z. For example, the saliency data 351 may include data indicating time periods associated with a interesting portion (e.g., may indicate that the interesting portion is between time T0 and T1, as illustrated in FIG. 2). In another example, the saliency data may include an identifier for the video (e.g., a string, text, numeric value, alphanumeric value, etc.). The saliency data 351 may also include data indicative of a saliency score for a portion of a video. For example, the saliency data may include a value for the saliency score for the portion of the video.

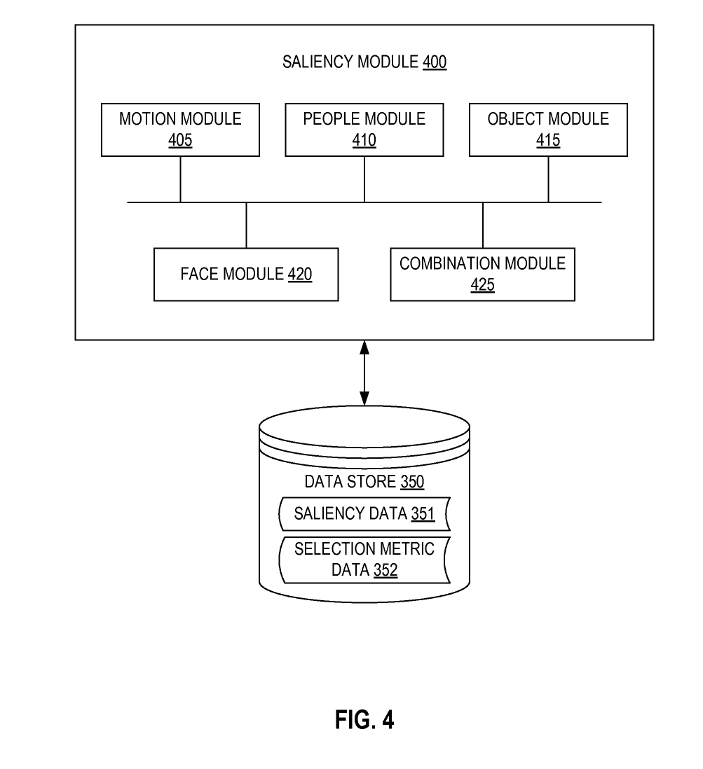

FIG. 4 is a block diagram illustrating a saliency module 400, in accordance with one embodiment of the present disclosure. The saliency module 400 includes a motion module 405, a people module 410, an object module 415, a face module 420, and optionally a combination module 425. More or less components may be included in the saliency module 400 without loss of generality. For example, two of the modules may be combined into a single module, or one of the modules may be divided into two or more modules. In one embodiment, one or more of the modules may reside on different computing devices (e.g., different server computers). In one embodiment, the when the saliency module 400 identifies interesting portions and generates a content item (e.g., a combined content item or video 250 illustrated in FIG. 2), the saliency module may include the combination module 425. In another embodiment, the saliency module 400 may include a combination module 425 when the saliency module 400 operates as a server saliency module (e.g., server saliency module 335 illustrated in FIG. 3).

In one embodiment, the motion module 405 may analyze and/or process videos to identify the motion of one or more objects and/or people depicted in the videos (as discussed above in conjunction with FIGS. 1 and 3). The motion module 405 may determine that a portion of a video and/or image is interesting (e.g., may be of interest to a viewer) based on the motion of one or more objects and/or people depicted in the video and/or image. In one embodiment, the motion module 405 may identify foreground motion based on feature points (as discussed above in conjunction with FIG. 3). The motion module 405 may use various motion detection methods, operations, algorithms, functions, techniques, etc., to determine the motion of the objects and/or people in a video. The saliency module 400 may determine a saliency score for the portion of the video based on, at least in part, the motion detected by the motion module 405.

In another embodiment, the people module 410 may analyze videos and/or images to determine whether people are depicted in the videos and/or images. The people module 410 may determine that a portion of a video and/or image is interesting (e.g., may be of interest to a viewer) based on whether one or more people are depicted in the videos and/or images (as discussed above in conjunction with FIGS. 1 and 3). The people module 410 may identify people depicted in the videos using various methods, operations, algorithms, functions, and/or techniques (e.g., using facial detection algorithms, a deformable parts model, etc., as discussed above in conjunction with FIGS. 1 and 3). The saliency module 400 may determine a saliency score for the portion of the video based on, at least in part, the people detected by the people module 410.

In one embodiment, the object module 415 may analyze videos to determine whether one or more objects are depicted in the videos. The object module 415 may determine that a portion of a video and/or image is interesting (e.g., may be of interest to a viewer) based on whether one or more objects are depicted in the videos and/or images. The object module 415 may identify objects depicted in the videos using various methods, operations, algorithms, functions, and/or techniques (e.g., may use a deformable parts model, a particle filter, a Markov chain Monte Carlo algorithm, etc., as discussed above in conjunction with FIGS. 1 and 3) to identify objects depicted in the videos 320A through 320A. In one embodiment, the object module 415 may identify one or more objects based on the type of the event (as discussed above in conjunction with FIGS. 1 and 3). The saliency module 400 may determine a saliency score for the portion of the video based on, at least in part, the objects detected by object module 415.

In another embodiment, the face module 420 may analyze videos to determine a location where one or more people in an audience at the event location, are looking. The face module 420 may be able to determine that the person's face is turned to a certain direction based on the position of eyes, ears, nose, and/or mouth of person's face (as discussed above in conjunction with FIGS. 1 and 3). The face module 420 may identify a vector/line for each face depicted in a portion of a video. The face module 420 may determine a location where multiple vectors/lines intersect and may determine that the location where the people in the audience are looking. The saliency module 400 may determine a saliency score for the portion of the video based on, at least in part, the people location determined by face module 420.

In one embodiment, combination module 425 may analyze and/or process the interesting portions of the videos to generate a combined video (e.g., a content item) based on the interesting portions. The combination module 425 may identify a subset of the interesting portions identified by other saliency modules and may generate the combined video based on the subset of the interesting portions of the videos (as discussed above in conjunction with FIGS. 1-3). The combination module 425 may use one or more selection metrics (e.g., distance, length, etc.) when selecting interesting portions from the videos to be used to generate the combined content item. The selection metric data 352 may include values, thresholds, and/or other data that may be used by the combination module 425 to identify interesting portions to include in the combined video. In one embodiment, when multiple interesting portions are associated with the same period of time (e.g., same time period), the combination module 425 may select one of the multiple interesting portions based on a saliency score associated with each of the multiple interesting portions. In another embodiment, the combination module 425 may identify a non-interesting portion when no interesting portions are identified for a period of time.

The saliency module 400 is communicatively coupled to the data store 350. For example, the saliency module 400 may be coupled to the data store 350 via a network (e.g., via network 305 as illustrated in FIG. 3). In another example, the data store 350 may be coupled directly to a server where the saliency module 400 resides (e.g., may be directly coupled to media server 330). The data store 350 may be a memory (e.g., random access memory), a cache, a drive (e.g., a hard drive), a flash drive, a database system, or another type of component or device capable of storing data. The data store 350 may also include multiple storage components (e.g., multiple drives or multiple databases) that may also span multiple computing devices (e.g., multiple server computers). As discussed above in conjunction with FIG. 3, the data store 350 includes saliency data 351 and selection metric data 352.

In one embodiment, the saliency module 400 may receive user input identifying additional interesting portions and/or identifying a portion as non-interesting. For example, the saliency module 400 may receive user input indicating that a portion that was not identified by a interesting module as interesting, is a interesting portion. In another example, the saliency module 400 may receive user input indicating that a portion that was identified as by a interesting module as interesting, is a not interesting portion. The saliency module 400 may update the saliency data 351 based on the user input. In another embodiment, the saliency module 400 may receive user input identifying portions of the videos, which are different than the portions identified by the combination module 425, to include in a combined video. For example, referring back to FIG. 2, a user may provide input indicating that portion 220A should not be included in the video 250 (e.g., the combined video) and that portion 210A should be included instead. The saliency module 400 may analyze the user input and may update the selection metric data 352 based on the user input. For example, if the user tends to select portions that are longer than forty-five seconds in length, the saliency module 400 may update the selection metric (e.g., a minimum length metric) to a value of forty-five seconds.

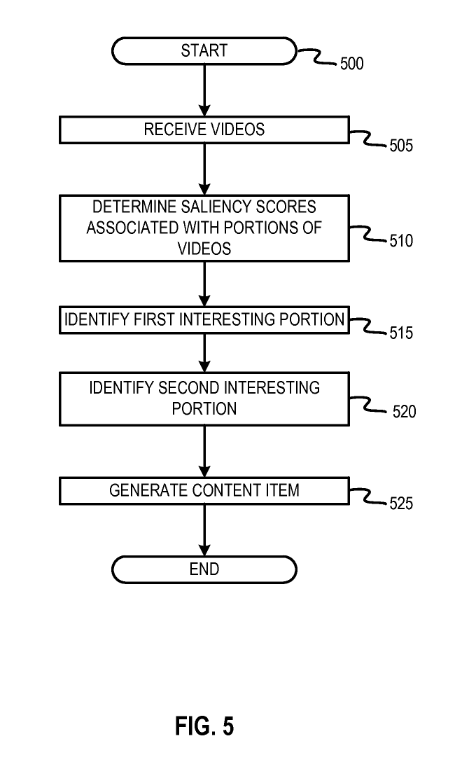

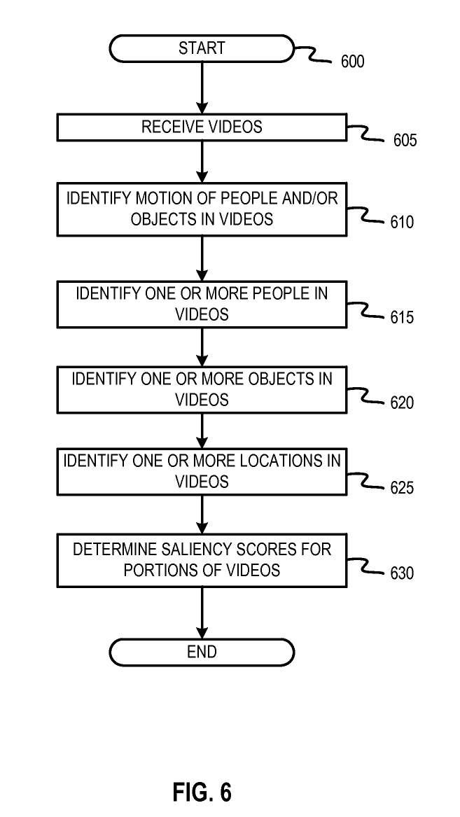

FIGS. 5 through 6 are flow diagrams illustrating methods of identifying interesting portions of videos. For simplicity of explanation, the methods are depicted and described as a series of acts. However, acts in accordance with this disclosure can occur in various orders and/or concurrently and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events.

FIG. 5 is a flow diagram illustrating a method of identifying interesting portions of videos, in accordance with one embodiment of the present disclosure. The method 500 may be performed by processing logic that comprises hardware (e.g., circuitry, dedicated logic, programmable logic, microcode, etc.), software (e.g., instructions run on a processor to perform hardware simulation), or a combination thereof. In one embodiment, method 500 may be performed by a saliency module, as illustrated in FIGS. 3 and 4.

Referring to FIG. 5, the method 500 begins at block 505 where the processing logic receives a plurality of videos. For example, the processing logic may receive one or videos captured by one or more cameras (as discussed above in conjunction with FIGS. 1-4). The one or more videos may depict an event that occurs at an event location, from different viewpoints. At block 510, the processing logic determines saliency scores associated with different portions of the plurality of videos. For example, as discussed above in conjunction with FIGS. 1-4, the processing logic may determine or calculate saliency scores for different portions of a video. At block 515, the processing logic may identify a first interesting portion from a first video. For example (as discussed above in conjunction with FIGS. 1-4), the processing logic may identify the first interesting portion because the first interesting portion has the highest saliency score out of a plurality of saliency scores associated with a plurality of portions of different videos. In another example, the processing logic may also identify the first interesting portion based on one or more selection metrics (as discussed above in conjunction with FIGS. 1-4).

At block 520, the processing logic may identify a second interesting portion from a second video. For example (as discussed above in conjunction with FIGS. 1-4), the processing logic may identify the second interesting portion because the second interesting portion has the highest saliency score out of a plurality of saliency scores associated with a plurality of portions of different videos. In another example, the processing logic may also identify the second interesting portion based on one or more selection metrics (as discussed above in conjunction with FIGS. 1-4). At block 525, the processing logic may generate a content item (e.g., a combined video) that includes the first interesting portion and the second interesting portion. The processing logic may generate the content item by combining and/or splicing the first interesting portion and the second interesting portion together to generate the content item (as discussed above in conjunction with FIGS. 1-4). After block 525, the method 500 ends.

FIG. 6 is a flow diagram illustrating a method of identifying interesting portions of videos, in accordance with one another of the present disclosure. The method 600 may be performed by processing logic that comprises hardware (e.g., circuitry, dedicated logic, programmable logic, microcode, etc.), software (e.g., instructions run on a processor to perform hardware simulation), or a combination thereof. In one embodiment, method 600 may be performed by a saliency module, as illustrated in FIGS. 3 and 4.

Referring to FIG. 6, the method 600 begins at block 605 where the processing logic receives a plurality of videos. For example, the processing logic may receive one or more videos captured by one or more cameras (as discussed above in conjunction with FIGS. 1-4) and audio and/or positioning data generated by one or more cameras, IMUs and/or wearable computers. The one or more videos may depict an event that occurs at an event location, from different viewpoints. At block 610, the processing logic may optionally identify the motion of one or more objects and/or people depicted in the portions of the videos. For example, the processing logic may identify the motion of objects and/or people in the foregrounds of the videos (as discussed above in conjunction with FIGS. 1-4). At block 615, the processing logic may optionally identify one or more people depicted in the portions of the videos. For example, the processing logic may identify the people using a deformable parts model (as discussed above in conjunction with FIGS. 1-4). At block 620, the processing logic may optionally identify one or more objects depicted in the portions of the videos. For example, the processing logic may identify the objects using a particle filter or a Markov chain Monte Carlo algorithm (as discussed above in conjunction with FIGS. 1-4).

At block 625, the processing logic may identify locations where people depicted in the videos are looking. For example, the processing logic may analyze the faces of people depicted in the videos (as discussed above in conjunction with FIGS. 1-4). The processing logic may determine a line/vector for each face and the line/vector may indicate where each face is looking. The processing logic may identify one or more locations based on the intersections of the lines/vectors for the faces of the people depicted in the videos (as discussed above in conjunction with FIGS. 1-4). In some embodiments, each of the blocks 610 through 625 may be optional and the processing logic may perform any combination of the blocks 610 through 625. For example, the processing logic may perform block 610 but may not perform blocks 615 through 625. In another example, the processing logic may perform block 615 but may not perform blocks 610, 620, and 625. At block 630, the processing logic may determine (e.g., calculate, generate, obtain, etc.) saliency scores for different portions of the videos. The saliency scores for the portions of the videos may be based on one or more of people depicted in the videos, objects depicted in the videos, the motion of objects/people depicted in the videos, and the locations where people in the video may be looking (as discussed above in conjunction with FIGS. 1-4). After block 630, the method 600 ends.

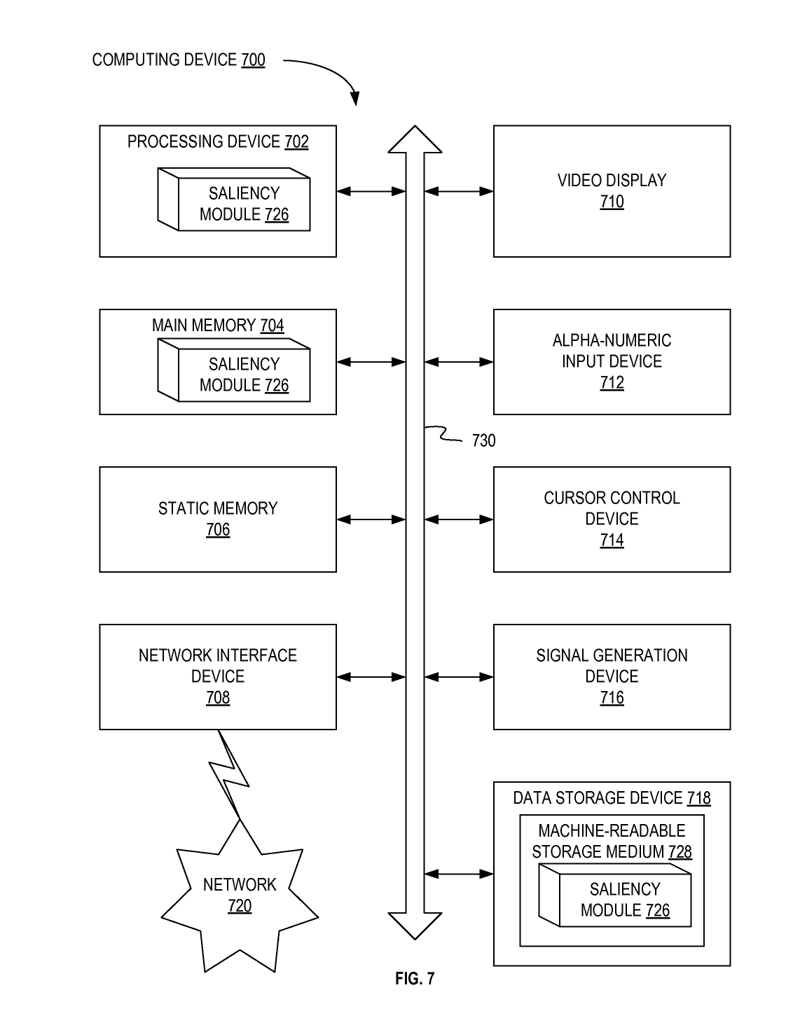

FIG. 7 illustrates a diagrammatic representation of a machine in the example form of a computing device 700 within which a set of instructions, for causing the machine to perform any one or more of the methodologies discussed herein, may be executed. The computing device 700 may be a mobile phone, a smart phone, a netbook computer, a rackmount server, a router computer, a server computer, a personal computer, a mainframe computer, a laptop computer, a tablet computer, a desktop computer etc., within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server machine in client-server network environment. The machine may be a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computing device 700 includes a processing device (e.g., a processor) 702, a main memory 704 (e.g., read-only memory (ROM), flash memory, dynamic random access memory (DRAM) such as synchronous DRAM (SDRAM)), a static memory 706 (e.g., flash memory, static random access memory (SRAM)) and a data storage device 718, which communicate with each other via a bus 730.

Processing device 702 represents one or more general-purpose processing devices such as a microprocessor, central processing unit, or the like. More particularly, the processing device 702 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 702 may also be one or more special-purpose processing devices such as an application specific integrated circuit (ASIC), a field programmable gate array (FPGA), a digital signal processor (DSP), network processor, or the like. The processing device 702 is configured to execute saliency module 726 for performing the operations and steps discussed herein.

The computing device 700 may further include a network interface device 708 which may communicate with a network 720. The computing device 700 also may include a video display unit 710 (e.g., a liquid crystal display (LCD) or a cathode ray tube (CRT)), an alphanumeric input device 712 (e.g., a keyboard), a cursor control device 714 (e.g., a mouse) and a signal generation device 716 (e.g., a speaker). In one embodiment, the video display unit 710, the alphanumeric input device 712, and the cursor control device 714 may be combined into a single component or device (e.g., an LCD touch screen).

The data storage device 718 may include a computer-readable storage medium 728 on which is stored one or more sets of instructions (e.g., saliency module 726) embodying any one or more of the methodologies or functions described herein. The saliency module 726 may also reside, completely or at least partially, within the main memory 704 and/or within the processing device 702 during execution thereof by the computing device 700, the main memory 704 and the processing device 702 also constituting computer-readable media. The instructions may further be transmitted or received over a network 720 via the network interface device 708.

While the computer-readable storage medium 728 is shown in an example embodiment to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media and magnetic media.

In the above description, numerous details are set forth. It will be apparent, however, to one of ordinary skill in the art having the benefit of this disclosure, that embodiments of the disclosure may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying,” “receiving,” “generating,” “determining,” “analyzing,” “comparing,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments of the disclosure also relate to an apparatus for performing the operations herein. This apparatus may be specially constructed for the required purposes, or it may comprise a general purpose computer selectively activated or reconfigured by a computer program stored in the computer. Such a computer program may be stored in a non-transitory computer readable storage medium, such as, but not limited to, any type of disk including floppy disks, optical disks, CD-ROMs and magnetic-optical disks, read-only memories (ROMs), random access memories (RAMs), EPROMs, EEPROMs, magnetic or optical cards, flash memory, or any type of media suitable for storing electronic instructions.

The words “example” or “exemplary” are used herein to mean serving as an example, instance, or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

The algorithms and displays presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems will appear from the description below. In addition, the present disclosure is not described with reference to any particular programming language. It will be appreciated that a variety of programming languages may be used to implement the teachings of the disclosure as described herein.

The above description sets forth numerous specific details such as examples of specific systems, components, methods and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth above are merely examples. Particular implementations may vary from these example details and still be contemplated to be within the scope of the present disclosure.

It is to be understood that the above description is intended to be illustrative and not restrictive. Many other embodiments will be apparent to those of skill in the art upon reading and understanding the above description. The scope of the disclosure should, therefore, be determined with reference to the appended claims, along with the full scope of equivalents to which such claims are entitled.

1. A method comprising:
receiving a plurality of videos of an event, wherein each video originates from a camera in a plurality of cameras, wherein operation of the plurality of cameras are synchronized with each other, and wherein each video is associated with a viewpoint of the event;
determining first saliency scores for portions of a first video of the plurality of videos and second saliency scores for portions of a second video of the plurality of videos, wherein the first saliency scores and second saliency scores are based on:
(i) a motion of one or more objects in corresponding portions of the first video and a motion of one or more objects in corresponding portions of the second video respectively,
(ii) a number of objects depicted in the corresponding portions of the first video and the corresponding portions of the second video respectively, wherein a larger number of objects in a portion of the first video or the second video results in a higher saliency score for the portion of the first video or the second video; and
(iii) at least one of:
a type of event,
rules associated with the type of event,
a schedule associated with the event,
a presence of one or more objects associated with the type of event in the corresponding portions of the first video and the corresponding portions of the second video respectively,
a location where one or more people in an audience are looking, in the corresponding portions of the first video and the corresponding portions of the second video respectively; and
identifying, based on the first saliency scores, a first interesting portion in the first video, and identifying, based on the second saliency scores, a second interesting portion in the second video, wherein the first interesting portion is associated with a first time period, and the second interesting portion is associated with a second time period; and
generating a content item comprising the first interesting portion and the second interesting portion.

2. The method of claim 1, wherein identifying the first interesting portion and the second interesting portion comprises:
determining a plurality of saliency scores associated with different portions of the plurality of videos, the plurality of saliency scores comprising the first saliency scores and the second saliency scores.

3. The method of claim 2, wherein determining the plurality of saliency scores associated with different portions of the plurality of videos comprises:
analyzing motions of objects or people depicted in the different portions of the plurality of videos; and
determining the plurality of saliency scores based on the motions of the objects or the people depicted in the different portions.

4. The method of claim 2, wherein determining the plurality of saliency scores associated with different portions of the plurality of videos comprises:
identifying one or more people depicted in the different portions of the plurality of videos; and
determining the plurality of saliency scores based on the one or more people depicted in the different portions.

5. The method of claim 2, wherein determining the plurality of saliency scores associated with different portions of the plurality of videos comprises:
analyzing faces of people depicted in the different portions of the plurality of videos;
determining the location based on the faces of the people; and
determining the plurality of saliency scores based on the location.

6. The method of claim 2, wherein determining the plurality of saliency scores associated with different portions of the plurality of videos comprises:
identifying one or more objects depicted in the different portions of the plurality of videos; and
determining the plurality of saliency scores based on the one or more objects.

7. (canceled)

8. (canceled)

9. The method of claim 1, wherein the first interesting portion and the second interesting portion do not overlap in time.

10. The method of claim 1, wherein generating the content item comprising the first interesting portion and the second interesting portion comprises:
generating the content item based on three or more selection metrics.

11. A system comprising:
a memory; and
a processing device, coupled to the memory, to:
receive a plurality of videos of an event, wherein each video originates from a camera in a plurality of cameras, wherein operation of the plurality of cameras are synchronized with each other, and wherein each video is associated with a viewpoint of the event;
determine first saliency scores for portions of a first video of the plurality of videos and second saliency scores for portions of a second video of the plurality of videos, wherein the first saliency scores and second saliency scores are based on:
(i) a motion of one or more objects in corresponding portions of the first video and a motion of one or more objects in corresponding portions of the second video respectively,
(ii) a number of objects depicted in the corresponding portions of the first video and the corresponding portions of the second video respectively, wherein a larger number of objects in a portion of the first video or the second video results in a higher saliency score for the portion of the first video or the second video; and
(iii) at least one of:
a type of event,
rules associated with the type of event,
a schedule associated with the event,
a presence of one or more objects associated with the type of event in the corresponding portions of the first video and the corresponding portions of the second video respectively,
a location where one or more people in an audience are looking, in the corresponding portions of the first video and the corresponding portions of the second video respectively; and
identify, based on the first saliency scores, a first interesting portion in the first video, and identify, based on the second saliency scores, a second interesting portion in the second video, wherein the first interesting portion is associated with a first time period, and the second interesting portion is associated with a second time period; and
generate a content item comprising the first interesting portion and the second interesting portion.

12. The system of claim 11, wherein the processing device is to identify the first interesting portion and the second interesting portion by:
determining a plurality of saliency scores associated with different portions of the plurality of videos, the plurality of saliency scores comprising the first saliency scores and the second saliency scores.

13. The system of claim 12, wherein the processing device is to determine the plurality of saliency scores associated with different portions of the plurality of videos by:
analyzing motions of objects or people depicted in the different portions of the plurality of videos; and
determining the plurality of saliency scores based on the motions of the objects or the people depicted in the different portions.

14. The system of claim 12, wherein the processing device is to determine the plurality of saliency scores associated with different portions of the plurality of videos by:
identifying one or more people depicted in the different portions of the plurality of videos; and
determining the plurality of saliency scores based on the one or more people depicted in the different portions.

15. The system of claim 12, wherein the processing device is to determine the plurality of saliency scores associated with different portions of the plurality of videos by:
analyzing faces of people depicted in the different portions of the plurality of videos;
determining the location based on the faces of the people; and
determining the plurality of saliency scores based on the location.

16. The system of claim 12, wherein the processing device is to determine the plurality of saliency scores associated with different portions of the plurality of videos by:
identifying one or more objects depicted in the different portions of the plurality of videos; and
determining the plurality of saliency scores based on the one or more objects.

17. (canceled)

18. (canceled)

19. A non-transitory computer readable storage medium storing instructions which, when executed, cause a processing device to perform operations comprising:
receiving a plurality of videos of an event, wherein each video originates from a camera in a plurality of cameras, wherein operation of the plurality of cameras are synchronized with each other, and wherein each video is associated with a viewpoint of the event;
determining first saliency scores for portions of a first video of the plurality of videos and second saliency scores for portions of a second video of the plurality of videos, wherein the first saliency scores and second saliency scores are based on:
(i) a motion of one or more objects in corresponding portions of the first video and a motion of one or more objects in corresponding portions of the second video respectively,
(ii) a number of objects depicted in the corresponding portions of the first video and the corresponding portions of the second video respectively, wherein a larger number of objects in a portion of the first video or the second video results in a higher saliency score for the portion of the first video or the second video; and
(iii) at least one of:
a type of event,
rules associated with the type of event,
a schedule associated with the event,
a presence of one or more objects associated with the type of event in the corresponding portions of the first video and the corresponding portions of the second video respectively,
a location where one or more people in an audience are looking, in the corresponding portions of the first video and the corresponding portions of the second video respectively; and
identifying, based on the first saliency scores, a first interesting portion in the first video, and identifying, based on the second saliency scores, a second interesting portion in the second video, wherein the first interesting portion is associated with a first time period, and the second interesting portion is associated with a second time period; and
generating a content item comprising the first interesting portion and the second interesting portion.

20. The non-transitory computer readable storage medium of claim 19, wherein identifying the first interesting portion and the second interesting portion comprises:
determining a plurality of saliency scores associated with different portions of the plurality of videos, the plurality of saliency scores comprising the first saliency scores and the second saliency scores.

21. The non-transitory computer readable storage medium of claim 19, wherein determining the plurality of saliency scores associated with different portions of the plurality of videos comprises:
analyzing motions of objects or people depicted in the different portions of the plurality of videos; and
determining the plurality of saliency scores based on the motions of the objects or the people depicted in the different portions.

22. The non-transitory computer readable storage medium of claim 19, wherein determining the plurality of saliency scores associated with different portions of the plurality of videos comprises:
identifying one or more people depicted in the different portions of the plurality of videos; and
determining the plurality of saliency scores based on the one or more people depicted in the different portions.

23. The non-transitory computer readable storage medium of claim 19, wherein determining the plurality of saliency scores associated with different portions of the plurality of videos comprises:
analyzing faces of people depicted in the different portions of the plurality of videos;
determining the location based on the faces of the people; and
determining the plurality of saliency scores based on the location.

24. The non-transitory computer readable storage medium of claim 19, wherein determining the plurality of saliency scores associated with different portions of the plurality of videos comprises:
identifying one or more objects depicted in the different portions of the plurality of videos; and
determining the plurality of saliency scores based on the one or more objects.

25. (canceled)

26. (canceled)
